(19) United States
(12) Patent Application Publication
(10) Pub. No.: US 2026/0318242 A1
(43) Pub. Date: Oct. 15, 2026

(54) PASSIVE PUMP SWITCHOVER

(71) Applicant: Eaton Intelligent Power Limited, Dublin 4 (IE)

(72) Inventor: Alan Retersdorf, Avon, CT (US)

(73) Assignee: Eaton Intelligent Power Limited, Dublin 4 (IE)

(21) Appl. No.: 19/351,825

(22) Filed: Oct. 7, 2025

Related U.S. Application Data
(60) Provisional application No. 63/704,109, filed on Oct. 7, 2024.

(51) Int. Cl. F01P 7/14; B64D 33/08

(52) U.S. Cl. CPC F01P 7/14; B64D 33/08; F01P 2007/146; F01P 2031/18; F01P 2050/20

(57) ABSTRACT

A thermal management system includes multiple, normally isolated thermal sub-systems that each manage respective equipment. The thermal sub-systems can be automatically interconnected in response to local pressure within the sub-systems. When interconnected, one or more components (e.g., a pump) of one sub-system can act on the equipment managed by each of the interconnected sub-systems. The isolation of the sub-systems can be actively imposed, however, when a leak in one sub-system is detected.

### CROSS-REFERENCE TO RELATED APPLICATIONS

This application claims the benefit of U.S. Application No. 63/704,109, filed Oct. 7, 2024, and titled PASSIVE PUMP SWITCHOVER, the disclosure of which is hereby incorporated herein by reference in its entirety.

### BACKGROUND

Thermal management systems provide cooling to various types of heat-generating equipment. For example, thermal management can be provided at an aircraft propulsion system. In general, a thermal management system includes a coolant (e.g., water, ethylene glycol, etc.) that is cycled by a pump along conduits between a heat exchanger and the equipment to be cooled.

### SUMMARY

A thermal management system includes a first thermal sub-system configured to thermally regulate first equipment and a second thermal sub-system configured to thermally regulate second equipment that is different from the first equipment. The thermal management system is configured to automatically transition between a normal operating state, a first assist state, and a second assist state. The first and second thermal sub-systems are isolated from each other when the thermal management system is configured in the normal operating state. The thermal sub-systems are connected together to regulate the first and second equipment in each of the assist states. In particular, the second thermal sub-system controls the flow of coolant in the first assist state and the first thermal sub-system controls the flow of coolant in the second assist state.

In certain implementations, each thermal sub-system includes a pump configured to deliver coolant along a respective local pathway to respective equipment. A first cross-over path connects the local pathways downstream of the pumps and a second cross-over path connects the local pathways upstream of the pumps. Accordingly, one of the pumps can cycle the coolant through both sets of local pathways if the other pump encounters a fault (e.g., ceases to operate, ceases to operate at the needed system pressure, etc.). This ability of one sub-system to take on responsibility of the equipment in other sub-systems provides redundancy, thereby enhancing the reliability of the system.

In certain implementations, a passive valve arrangement allows the thermal management system to automatically transition from the normal operating state to the assist state when the pressure drops within one of the systems. For example, when both thermal sub-systems are operating normally, the pressure within the sub-systems will apply relatively equal pressure at the passive valve arrangement. When the pressure drops in one thermal sub-system, however, the passive valve arrangement will allow flow from the higher pressure sub-system to flow through the lower pressure sub-system. Similarly, the passive valve arrangement will automatically transition the thermal management system back to normal operation if the malfunctioning pump is fixed. Transitioning states without the need of active components further enhances the reliability of the thermal management system.

An active valve arrangement can be added to the thermal management system to isolate the local pathways in the event of a leak. For example, the active valve arrangement can be managed by a controller receiving input from one or more sensors within the system to determine the presence of a leak.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a schematic diagram of an example thermal management system configured in a normal operating state, the thermal management system including thermal sub-systems interconnected by cross-over paths and a passive valve arrangement.

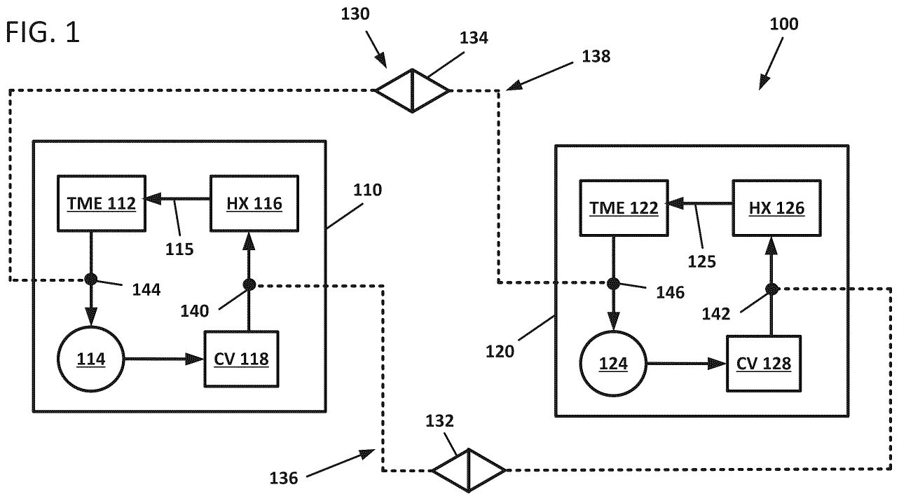

FIG. 2 shows the thermal management system of FIG. 1 configured in a first assist state in which a pump of the second sub-system drives fluid between all interlinked sub-systems.

FIG. 3 shows the thermal management system of FIG. 1 configured in a second assist state in which a pump of the first sub-system drives fluid between all interlinked sub-systems.

FIG. 4 shows an example implementation of a valve arrangement suitable for use in the passive valve of FIGS. 1-3.

FIG. 5 adds an active valve arrangement to the thermal management system of FIG. 1, the active valve arrangement being configured in an open state.

FIG. 6 shows the passive valve arrangement of the thermal management system of FIG. 5 configured in the first assist state while the active valve arrangement is configured in the open state.

FIG. 7 shows the thermal management system of FIG. 6 while the active valve arrangement is configured in an isolate state.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

A thermal management system 100 includes multiple thermal sub-systems 110, 120 that each independently operate to thermally regulate respective equipment 112, 122. While two thermal sub-systems 110, 120 are shown in the figures, it will be understood that the thermal management system 100 could include additional thermal sub-systems. Each thermal sub-system 110, 120 includes a respective pump 114, 124 configured to deliver coolant along a respective pathway 115, 125 to the respective equipment 112, 122.

In accordance with certain aspects of the disclosure, the thermal management system 100 is configured to transition between a normal operating state, a first assist state, and a second assist state. The first and second pathways 115, 125 are isolated from each other when the thermal management system 100 is configured in the normal operating state. The first pump 114 supplies coolant to both the first equipment 112 and the second equipment 122 when the when the thermal management system 100 is configured in the first assist state. The second pump 124 supplies coolant to both the first equipment 112 and the second equipment 122 when the when the thermal management system 100 is configured in the second assist state.

In certain implementations, the transition between the states occurs automatically upon a failure in one of the sub-systems 110, 120. For example, the transition is not controlled by active valves. In certain implementations, the transition is implemented using a passive valve arrangement 130. The passive valve arrangement 130 isolates the first and second pathways 115, 125 during normal operation. The passive valve arrangement 130 allows flow from a higher pressure one of the first and second pathways 115, 125 to a lower pressure one of the first and second pathways 115, 25 during component failure, thereby leading to a transition to one of the assist states.

In certain examples, the thermal sub-systems 110, 120 are interlinked using first and second cross-over paths 136, 138. For example, a first cross-over path 136 may connect the first pathway 115 at a first location 140 downstream of the first pump 114 to the second pathway 125 at a second location 142 downstream of the second pump 124. A second cross-over path 138 connects the first pathway 115 at a third location 144 upstream of the first pump 114 to the second pathway 125 at a fourth location 146 upstream of the second pump 124.

The passive valve arrangement 130 includes a first valve arrangement 132 disposed along the first cross-over path 136 and a second valve arrangement disposed along the second cross-over path 138. When pressure within the first and second pathways 115, 125 is about equal, the flow from either pathway 115, 125 to the first valve arrangement 132 will be about equal, thereby applying about equal pressure to the first valve arrangement 132. Accordingly, the first valve arrangement 132 will inhibit flow from either thermal sub-system 110, 120 into the other. When the pressure within one of the pathways 115, 125 is greater than the other, however, such as in the event of a pump failure in one of the thermal sub-systems 110, 120, the valve arrangements 132, 134 will allow flow from the higher pressure system to pass along the respective cross-over paths 136, 138 into the lower pressure system.

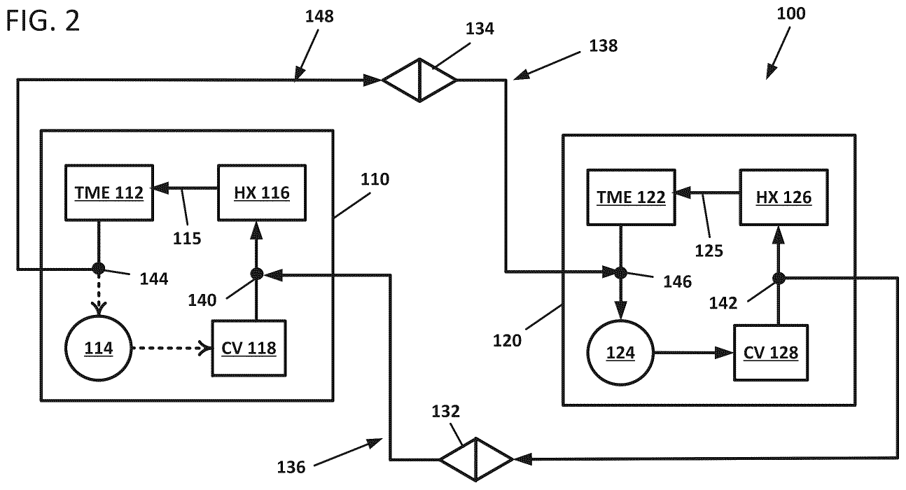

For example, FIG. 2 shows the thermal management system 100 configured in the first assist state. In FIG. 2, the pump 114 of the first thermal sub-system 110 has ceased operation. Accordingly, the pressure of the coolant within the first thermal sub-system 110 drops to a level lower than the pressure in the second thermal sub-system 120, which still has an operating pump 124. Accordingly, a portion of the coolant pressurized by the pump 124 in the second thermal sub-system 120 overcomes the coolant of the first thermal sub-system 110 at the first valve arrangement 132 and flows along the first cross-over path 136 to join the first pathway 115. Of course, another portion of the coolant pressurized by the pump 124 continues to flow along the second pathway 125.

Furthermore, the second pump 124 is drawing coolant towards itself along the second pathway 125 while the first pump 114 has ceased drawing coolant. Accordingly, the second valve arrangement 134 will feel a greater draw from the second thermal sub-system 120 and will open to allow flow from the location 144 upstream of the first pump 114 to travel along the second cross-over path 138 to the location 146 upstream of the second pump 124 to form a combined path 148. All of the coolant in both sub-systems 110, 120 cycles back to the second pump 124 along the combined path 148 in a first direction. Accordingly, the coolant driven by the second pump 124 passes through/by all of the equipment 112, 122 in the sub-systems 110, 120.

In certain examples, the coolant driven by the second pump 124 in FIG. 2 also passes through/by both heat exchangers 116, 126. The inclusion of both heat exchangers 116, 126 in the combined path 148 helps to compensate from the load produced by the equipment 112, 122. In the example shown, the first cross-over path 136 connects the first and second pathways 115, 125 at locations upstream of the heat exchangers 116, 126. In other examples, however, the first cross-over path 136 could connect the first and second pathways 115, 125 at locations downstream of the heat exchangers 116, 126.

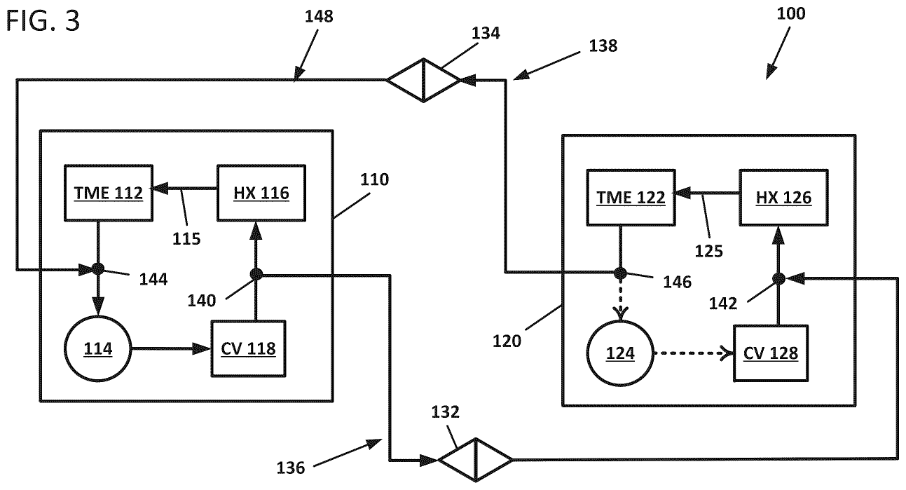

FIG. 3 shows the thermal management system 100 configured in the second assist state. In particular, FIG. 3 shows the second pump 124 in a non-operative state while the first pump 114 remains operational. In such a system, the pressure of the coolant within the second thermal sub-system 120 drops to a level lower than the pressure in the first thermal sub-system 110, resulting in the first and second valve arrangements 132, 134 allowing flow in the reverse direction compared to FIG. 2. Accordingly, the pump 114 of the first thermal sub-system 110 drives a first portion of the coolant along the local pathway 115 and a second portion of the coolant over the first cross-over path 136 to the second pathway 125. The second cross-over path 138 allows the second portion of the coolant to cycle back to the first pump 114.

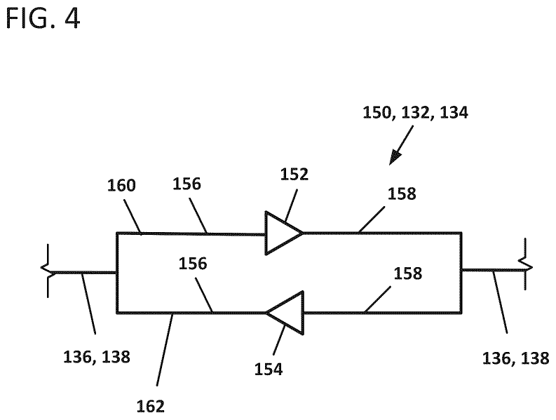

FIG. 4 shows an example implementation of a valve arrangement 150 suitable for use as the valve arrangement 132, 134 along the cross-over paths 136, 138. In FIG. 4, the valve arrangement 150 includes a first check valve 152 and a second check valve 154. The first check valve 152 opens only when the pressure from a first side 156 overcomes the pressure on the opposite, second side 158. The second check valve 154 opens only when the pressure from the second side 158 overcomes the pressure on the first side 156. The first and second check valves 152, 154 are disposed in parallel to each other. For example, the cross-over path 136, 138 may split into a first path section 160 and a second path section 162 running in parallel to each other before joining again. The first check valve 152 allows flow in a first direction from the first side 156 to the second side 158 along the first path section 160 when open. The second check valve 154 allows flow in a second direction from the second side 158 to the first side 156 along the second path section 162 when open. The check valves 152, 154 remain closed when the pressure on both sides 156, 158 is equal or about equal.

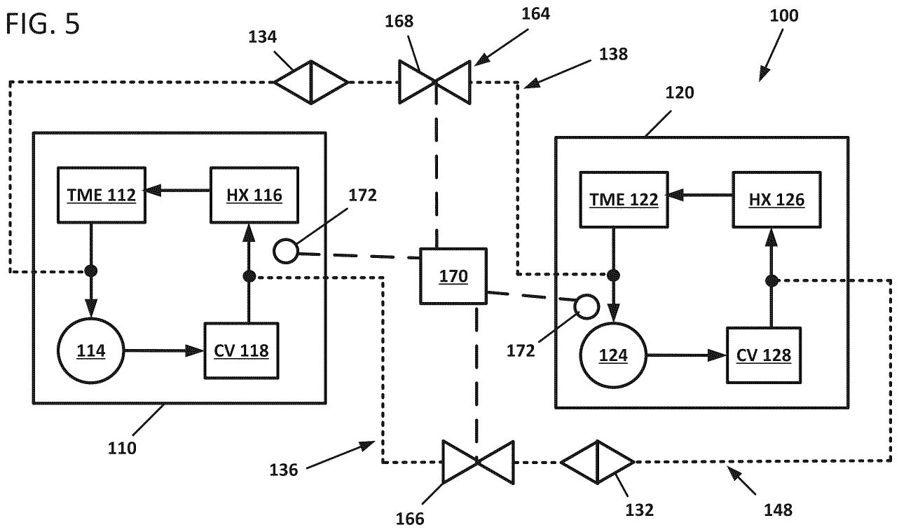

Referring to FIGS. 5-7, active protection may be added to the thermal management system 100 to guard against interlinking the sub-systems 110, 120 when a loss of local pressure is caused by a leak. For example, an active valve arrangement 164 can be disposed along the first and second cross-over paths 136, 138. The active valve arrangement 164 is controlled by a system controller 170 to transition between an open state and an isolate state. When in the isolate state, the active valve arrangement 150 isolates the first and second pathways 115, 125 regardless of any pressure differential between the sub-systems 110, 120. When in the open state, however, the active valve arrangement 150 allows the passive valve arrangement 130 to operate as described above.

In certain implementations, the system controller 170 is configured to receive input from one or more sensors 172 disposed at the thermal sub-systems 110, 120. In some examples, the sensors 172 are disposed at the pump 114, 124 to determine whether the pump 114, 124 is functional. In other examples, the sensors 172 are disposed at a respective accumulator disposed along the local pathway 115, 125 to check the volume of coolant being stored during normal operation. Other sensor types are possible. The system controller 170 analyses the input signals to determine whether any of the sub-systems 110, 120 has sprung a leak or is otherwise losing coolant. The system controller 170 issues shut-down instructions when a leak is detected.

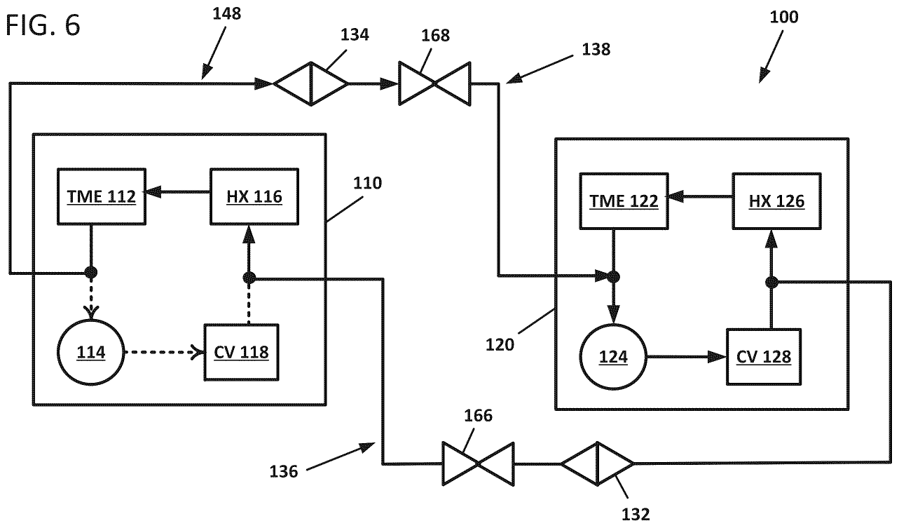

In certain implementations, the active valve arrangement 150 includes a first shut-down valve 166 disposed along the first cross-over path 136 and a second shut-down valve 168 disposed along the second cross-over path 138. During normal operation, the shut-down valves 166, 168 remain open regardless of the relative pressures of the sub-systems 110, 120. For example, FIG. 6 shows the thermal management system 100 configured in the first assist state while the shut-down valves 166, 168 remain open. Upon receiving shut-down instructions from the system controller 170, however, the shut-down valves 166, 168 close, thereby isolating the local pathways 115, 125 between the thermal sub-systems 110, 120.

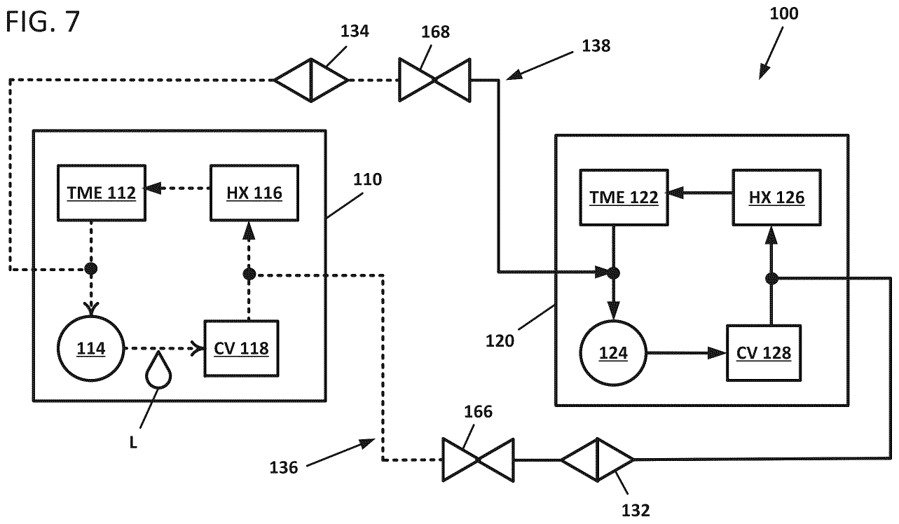

In certain examples, shut-down instructions are issued by the controller in the event of a leak L (e.g., see FIG. 7). Interlinking the sub-systems 110, 120 while one sub-system 110, 120 is leaking could result in leakage from all of the interlinked sub-systems. The active valve arrangement 164 protects against such an occurrence by isolating the sub-systems 110, 120 from each other in the event of a leak, even if one of the thermal sub-systems 110, 120 otherwise breaks down. For example, FIG. 7 shows the shut-down valves 166, 168 closed while the thermal management system 100 was configured in the first assist state. In such a configuration, the first equipment 112 is not thermally managed by either the first sub-system 110 or the second sub-system 120. However, the leak L in the first sub-system 110 does not affect the functioning of the second sub-system 120 so that the second equipment 122 remains thermally managed.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A thermal management system comprising:
a first thermal sub-system configured to deliver coolant to first equipment, the first thermal sub-system including a first pump, a first heat exchanger, and first conduits forming a first pathway from the first pump to the first heat exchanger and to the first equipment;
a second thermal sub-system configured to deliver coolant to second equipment, the second thermal sub-system including a second pump, a second heat exchanger, and second conduits forming a second pathway from the second pump to the second heat exchanger and to the second equipment;
a first cross-over path connecting the first pathway at a first location upstream of the first pump to the second pathway at a second location upstream of the second pump;
a second cross-over path connecting the first pathway at a third location downstream of the first pump to the second pathway at a fourth location downstream of the second pump;
a passive valve arrangement disposed along the first and second cross-over paths, the passive valve arrangement isolating the first and second pathways during normal operation, and the passive valve arrangement allowing flow from a higher pressure one of the first and second pathways to a lower pressure one of the first and second pathways during component failure.

2. The thermal management system of claim 1, wherein the passive valve arrangement includes a first valve arrangement disposed along the first cross-over path and a second valve arrangement disposed along the second cross-over path.

3. The thermal management system of claim 2, wherein the first valve arrangement includes a first check valve and a second check valve disposed in parallel.

4. The thermal management system of any of claims 1-3, further comprising:
a system controller; and
an active valve arrangement disposed along the first and second cross-over paths, the active valve arrangement being configured to transition between an open state and an isolate state in response to instructions from the system controller, wherein the active valve arrangement isolates the first and second pathways when in the isolate state.

5. The thermal management system of any of claims 1-4, wherein each of the first and second thermal sub-systems includes an internal check-valve disposed downstream of the pump and upstream of the second cross-over path.

6. The thermal management system of any of claims 1-5, wherein the second equipment is substantially the same as the first equipment.

7. The thermal management system of any of claims 1-6, wherein the second equipment is disposed at a different location from the first equipment.

8. The thermal management system of any of claims 1-7, wherein the first equipment forms part of an aircraft propulsion system.

9. A thermal management system comprising:
a first thermal sub-system including a first pump configured to deliver first coolant along a first pathway to first equipment;
a second thermal sub-system including a second pump configured to deliver second coolant along a second pathway to second equipment;
the thermal management system being configured to automatically transition between a normal operating state, a first assist state, and a second assist state, the first and second pathways being isolated from each other when the thermal management system is configured in the normal operating state, the first pump supplying the first coolant to both the first equipment and the second equipment when the when the thermal management system is configured in the first assist state, and the second pump supplying the second coolant to both the first equipment and the second equipment when the when the thermal management system is configured in the second assist state.

10. The thermal management system of claim 9, wherein the second equipment is substantially the same as the first equipment.

11. The thermal management system of any of claims 9 and 10, wherein the second equipment is disposed at a different location from the first equipment.

12. The thermal management system of any of claims 9-11, further comprising:
a system controller; and
an active valve arrangement, the active valve arrangement being configured to transition between an open state and an isolate state in response to instructions from the system controller, wherein the active valve arrangement isolates the first and second pathways when in the isolate state.

13. The thermal management system of any of claims 9-12, further comprising:
a first cross-over path connecting the first pathway at a first location upstream of the first pump to the second pathway at a second location upstream of the second pump; and
a second cross-over path connecting the first pathway at a third location downstream of the first pump to the second pathway at a fourth location downstream of the second pump.

14. The thermal management system of claim 13, further comprising
a first valve arrangement disposed along the first cross-over path, the first valve arrangement configured to enable fluid from a higher pressure one of the first and second pathways to flow to a lower pressure one of the first and second pathways; and
a second valve arrangement disposed along the second cross-over path, the second valve arrangement configured to enable fluid from a higher pressure one of the first and second pathways to flow to a lower pressure one of the first and second pathways.

15. The thermal management system of claim 14, wherein the first valve arrangement includes a first check valve and a second check valve disposed in parallel.

16. The thermal management system of any of claims 9-15, wherein the first equipment forms part of an aircraft propulsion system.

17. A method of thermal management of equipment, the method comprising:
operating a first thermal management pathway in isolation from a second thermal management pathway; and
automatically opening a cross-over path between the first and second thermal management pathways from a higher pressure one of the first and second thermal management pathways to a lower pressure one of the first and second thermal management pathways.

18. The method of claim 17, wherein the cross-over path is a first cross-over path, and wherein the method further comprises:
automatically opening the second cross-over path between the first and second thermal management pathways, wherein the first cross-over path connects the first pathway at a first location upstream of the first pump to the second pathway at a second location upstream of the second pump; and wherein the second cross-over path connecting the first pathway at a third location downstream of the first pump to the second pathway at a fourth location downstream of the second pump.

19. The method of claim 17, further comprising:
receiving at an active valve instructions from a system controller to isolate the first and second thermal management pathways; and
closing to isolate the isolate the first and second thermal management pathways in response to the instructions even if one of the first and second thermal management pathways is at a higher pressure than the other of the first and second thermal management pathways.

20. The method of claim 17, further comprising:
detecting at a system controller a pump a leak in one of the first and second thermal management pathways;
generating at the system controller instructions to isolate the first and second thermal management pathways; and
sending the instructions to the active valve.
